(19) United States
(12) Patent Application Publication
(10) Pub. No.: US 2016/0357519 A1
(43) Pub. Date: Dec. 8, 2016

(54) Natural Language Engine for Coding and Debugging

(71) Applicant: Microsoft Technology Licensing, LLC, Redmond, WA (US)

(72) Inventor: Fany Carolina Vargas, Richardson, TX (US)

(21) Appl. No.: 14/732,276

(22) Filed: Jun. 5, 2015

(51) Int. Cl. G06F 9/44; G10L 15/26; G06N 7/00; G06F 3/0488; G06F 11/36; G06F 17/30; G06F 3/16

(52) U.S. Cl. CPC G06F 8/34; G06F 17/30684; G10L 15/265; G06F 3/167; G06F 3/0488; G06F 17/30424; G06F 11/3664; G06F 8/35; G06N 7/005; G10L 2015/223

(57) ABSTRACT

Various embodiments provide techniques and devices for computer programming and/or computer program debugging via natural language content. In some examples, a natural language coding engine may receive natural language content and determine a result objective associated with the natural language content. The natural language content can be based at least in part on input by a user to a touchscreen of an electronic device, and/or spoken commands captured by a microphone of an electronic device. In some examples, the natural language coding engine may identify one or more code snippets associated with the result objective and generate programming code to accomplish at least a portion of the result objective. In some other examples, the natural language coding engine may cause the performance of a debugging command associated with the result objective.

### BACKGROUND

Typically, computer programming and computer program debugging are performed using a physical keyboard. With the proliferation of mobile devices of varying form factors, many digital devices are being designed with keyboard operation as a secondary consideration. For instance, many digital devices include touch screen interfaces for user input using a stylus or one or more fingers. In addition, many digital devices include microphones that permit users to operate digital devices with spoken commands.

### SUMMARY

This disclosure describes systems and methods for implementing a natural language coding engine for computer programming and/or computer program debugging via natural language content (e.g., verbs, phrases and clauses intended to act as controls for an electronic device). Such natural language content can include input by a user to a touchscreen of an electronic device, and/or spoken commands captured by a microphone of an electronic device. Further, the natural language coding engine may determine a result objective associated with the natural language content. In some instances, the natural language coding engine may generate programming instructions to accomplish the result objective. In some other instances, the natural language coding engine may cause the performance of one or more debugging commands to accomplish the result objective.

For example, an electronic device can implement a method comprising receiving, via a user input interface, natural language input from a user device, and determining a result objective associated with the natural language input. Further, the electronic device may identify a code snippet associated with the result objective, and determine a replacement parameter in the code snippet. In addition, the electronic device may generate executable code for performing the result objective based at least in part on substitution of the replacement parameter. Thereby, improving the functioning of electronic devices by providing more efficient means to perform computer programming and computer debugging.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs)), and/or other technique(s) as permitted by the context above and throughout the document.

### BRIEF DESCRIPTION OF THE DRAWINGS

The detailed description is set forth with reference to the accompanying figures. In the figures, the left-most digit of a reference number identifies the figure in which the reference number first appears. The use of the same reference numbers in different figures indicates similar or identical items or features.

FIGS. 1A and 1B are example interfaces for generating programming instructions via natural language input, according to various examples.

FIG. 2 is an example interface for computer program debugging via natural language input, according to various examples.

FIG. 3 is a block diagram depicting an environment for implementing a code snippet service, according to various examples.

FIG. 4 is a block diagram of an electronic device according to some examples.

FIG. 5 is a flow diagram illustrating a process for processing a code request, according to some examples.

FIG. 6 is a flow diagram illustrating a process for generating executable code via natural language input, according to some examples.

FIG. 7 is a flow diagram illustrating a process for performing debugging operations via natural language input, according to some examples.

### DETAILED DESCRIPTION

The following detailed description generally relates to a natural language coding engine for computer programming and/or computer program debugging via natural language content. Various examples describe techniques and architectures for a system that performs, among other things, receiving natural language content and determining a result objective associated with the natural language content. The natural language content can be based at least in part on input by a user to a touchscreen of an electronic device, and/or spoken commands captured by a microphone of an electronic device. Further, gesture input to the touchscreen of the electronic device may be used to compliment natural language content. In some instances, the natural language coding engine may identify one or more code snippets associated with the result objective and generate programming code to accomplish at least a portion of the result objective. In some other instances, the natural language coding engine may cause the performance of a debugging command associated with the result objective.

For example, a user of an electronic device may dictate “generate a script to display a list of all locally stored compressed files modified within the last month” to an electronic device. The natural language coding engine may convert the captured audio of the user's dictation to corresponding text. Further, the natural language coding engine may determine that the corresponding text includes a request to generate a script that identifies locally stored compressed files modified within the last month. In some examples, the natural language coding engine may request further information from the user in order to complete the request. For instance, the natural language coding engine may request that the user specify a display interface for displaying the list of compressed files modified within the month. In addition, the natural language coding engine may generate a script that locates locally stored compressed files, evaluates the last modified attribute of each compressed file to determine the group of compressed files that have been modified within the last month, and prints the group to a display interface of the electronic device.

As described herein, a “result objective” refers to one or more goals that are conveyed in the meaning of a communication. Unless otherwise explicitly noted or implied by the context of a particular sentence, “identifying,” “determining” or “detecting” a result objective in a communication refers to recognizing the presence of the result objective and determining at least partial meaning of the result objective. For example, the natural language coding engine may process an audio recording requesting the generation of a script to format file names in a specified directory. Identifying a result objective in the audio recording can mean recognizing the presence of a request to generate a script to perform an action in the audio recording, and determining the actions that need to be performed by the script (i.e., formatting file names in a specified directory).

Some example techniques for identifying a result objective may involve language analysis of at least one of input to a touchscreen of an electronic device or spoken input captured by an audio capture component of an electronic device. In some instances, the electronic device may convert the touchscreen input or spoken input to corresponding textual content prior to performing the analysis. Further, the analysis may include performing natural language processing (NLP) analysis on the textual content. In some embodiments, techniques for determining a result objective may be further based on one or more system resources, user preferences, user history, and aggregated usage information associated with a plurality of electronic devices.

In some examples, once the natural language coding engine has determined a result objective, the natural language coding engine may search a database to determine one or more code snippets associated with the result objective. For instance, the natural language coding engine may generate a search query associated with the result objective. In some examples, generating the search query may include identifying one or more keywords and constructing a search query comprising the identified keywords. Further, the natural language coding engine may perform a search of the database based at least in part on the search query. In addition, the natural language coding engine may present search results including one or more code snippets associated with the search query to the user. In some instances, the database may be a remote service including a plurality of code snippets. Further, the remote service may include search functionality for retrieving code snippets based at least in part on search terms. As described herein, a code snippet refers to re-usable source code, machine code, or text. In addition, a code snippet can range in size from a single programming definition, statement or expression to a block of code (e.g., sequence of definitions, statements and/or expressions). Further, a code snippet may be inserted into source code file or a script to achieve a particular functionality.

In some embodiments, the natural language coding engine can modify a code snippet to generate executable code capable of at least partial performance of a result objective. For instance, the natural language coding engine can identify one or more replacement parameters in a code snippet. Further, the natural language coding engine can substitute the replacement parameters within the code snippet. As described herein, a replacement parameter refers to a portion of a code snippet that can be replaced in order to tailor the code snippet to the result objective. Replacement parameters may include types, identifiers, definitions, annotations, statements, expressions, values, variables, and/or literals within a code snippet.

In some embodiments, a code snippet may be accompanied by information identifying one or more replacement parameters included in the code snippet. For instance, the code snippet may be associated with metadata identifying one or more portions of the code snippet that may be replaced in order to accomplish an intended result. Further, the metadata may include a description that provides guidance for substituting the replacement parameter. As an example, a code snippet may provide a block of reusable code for connecting to a database. Further, metadata associated with the code snippet may identify a value in the code snippet that should be replaced with an address and port of the database. As another example, metadata associated with the code snippet may identify a variable name that should be substituted with a literal that reflects the variable's purpose. In some cases, the natural language coding engine may be used to identify replacement parameters within a code snippet.

In some instances, the natural language coding engine may dynamically identify a portion of a code snippet as a replacement parameter based at least in part on the result objective. For instance, the natural language coding engine may determine that the result objective is to print information to a particular file. Further, the natural language coding engine may determine that an object included in code snippet represents a destination file for printing the information. Thus, the natural language coding engine may determine that an attribute of the object is a replacement parameter that should be set to a location of the particular file.

In some examples, the natural language coding engine may automatically substitute a replacement parameters based at least in part on the result objective. For instance, the result objective may include saving a file to a user's desktop. As such, the natural language coding engine may identify a replacement parameter that should be set to a destination folder, and substitute the replacement parameter with the path name of user's desktop. In some other examples, the natural language coding engine may request a value for a replacement parameter from a user. For instance, the result objective may include compressing a digital file. Further, the natural language coding engine may request a user specify the compression method to use when compressing the digital file.

In some embodiments, once the natural language coding engine has determined a result objective, the natural language coding engine may cause the performance of a debugging command by a debug application. The debug application may be capable of performing commands for various debugging tasks, such as examining symbols (e.g., names of variables, functions, and types), setting breakpoints, and so forth. For instance, the result objective may include determining one or more portions of software code that reference a specified variable. Further, the natural language coding engine may locate one or more portions of the software code that reference the specified variable, and display the one or more portions of the software code that reference the specified variable on a display interface.

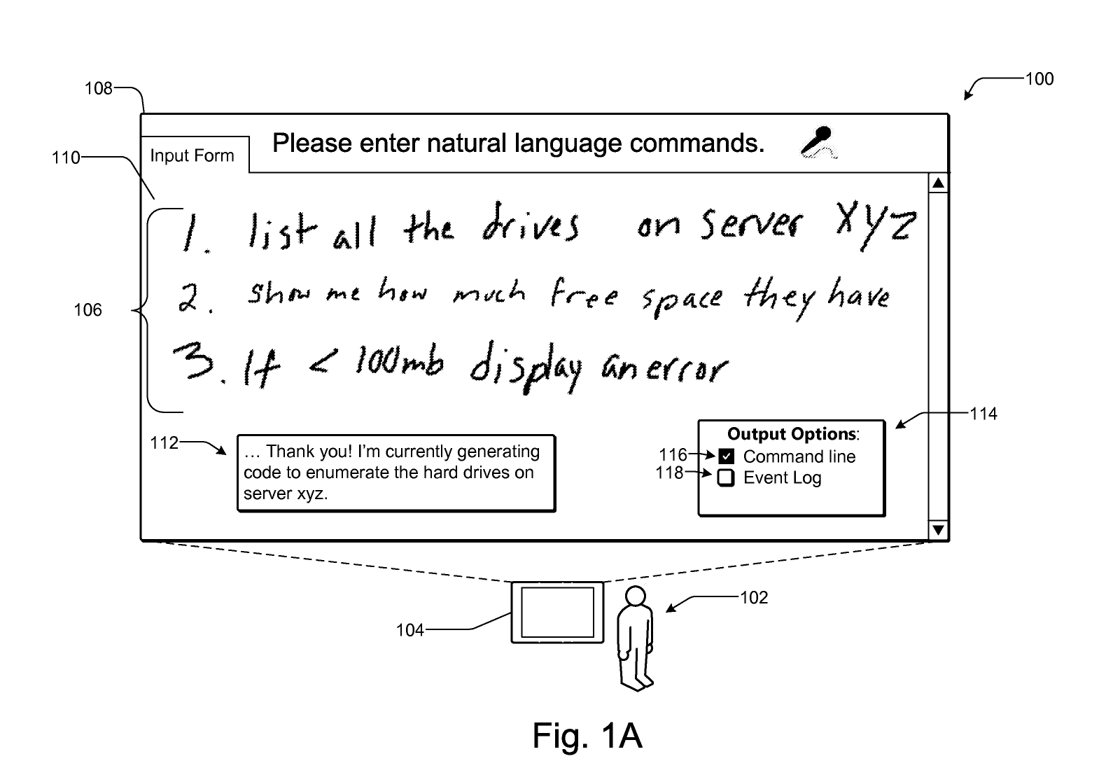

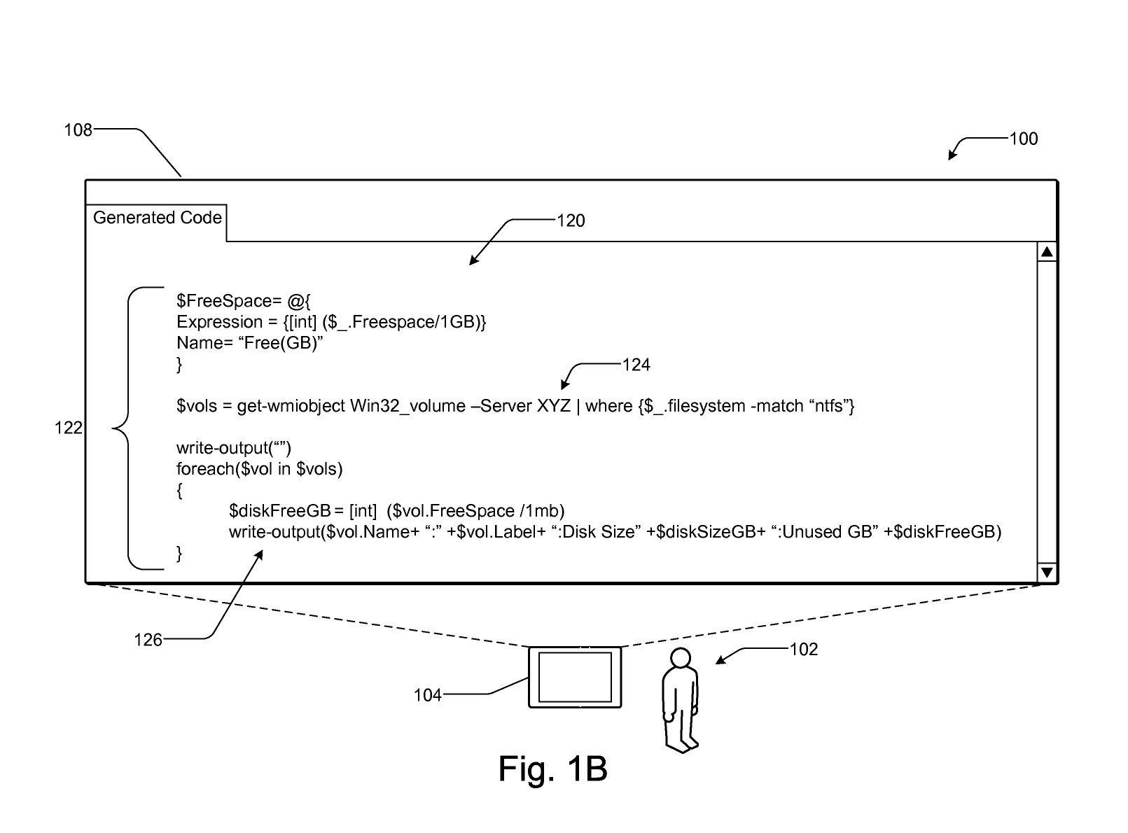

Various examples are described further with reference to FIGS. 1-7.

### Example Environments

FIGS. 1A and 1B illustrate example graphical user interfaces for generating programming instructions via natural language input. Referring to FIG. 1A, suppose that a user 102 endeavors to generate programming instructions that display an amount of free hard drive space for individual hard drives on a server device, and display an error if a hard drive has less than one hundred megabytes of free hard drive space.

As illustrated in FIG. 1A, the user 102 may provide handwritten input 106 via a touchscreen display 108 of the electronic device 104 or any other suitable communication technology. In some examples, the user 102 can utilize a stylus to write the handwritten input 106 within a designated input area 110 of a graphic user interface 100. As shown in FIG. 1A, the handwritten input 106 may describe one or more steps for displaying an amount of free hard drive space for individual hard drives on a server device, and displaying an error if a hard drive has less than 100 megabytes of free hard drive space. Further, as shown in FIG. 1A, the handwritten input may include one or more symbols, such as the “less-than” operator.

As discussed herein, the electronic device 102 can determine result objectives associated with the handwritten input 106 entered in the designated input area 110. For example, the electronic device 104 may determine that listing the hard drives of the server xyz with their corresponding amount of available hard drive space is a first result objective of the handwritten input 106. Further, the electronic device 104 may determine that displaying error messages to indicate that a hard drive includes less than 100 megabytes of available hard drive space is a second result objective of the handwritten input 106.

Once the electronic device 102 determines the result objectives of the handwritten input 106, the electronic device 102 may display status information 112 related to the generating programming instructions to accomplish the result objectives. As illustrated in FIG. 1A, the status information 112 may communicate to the user 102 of the electronic device 104 that the electronic device is 104 generating code to perform at least a portion of the handwritten input 106 (e.g., generating programming instructions to enumerate the disk on the server XYZ). Additionally, or alternatively, the electronic device 104 may communicate the status information to the user 102 via another component of the electronic device 104. For instance, the electronic device 104 may produce an audio event indicating that the electronic device 104 is generating code to perform at least a portion of the handwritten input 106.

FIG. 1A further illustrates a query dialog 114. The electronic device 104 may present the query dialog 114 to the user 102 to collect information for generating the programming instructions. As shown in FIG. 1, the query dialog 114 may present a plurality of output options that can be used to generate the programming instructions. As described herein, the electronic device 104 may determine information that might be helpful when generating the programming instructions, and request the information from the user 102 via the query dialog 114. Additionally, or alternatively, the electronic device 104 may request the information for generating the programming instructions via another component of the electronic device 104. For instance, the electronic device 104 may produce an audio event requesting the user 102 to provide the information.

In the illustrated example, the user 102 may wish to have the output printed to a command line of the electronic device 104. Therefore, the user 102 may select the “command line” control 116 to indicate that the output of the programming instructions should include instructions for printing information to the command line. In another instance, the user 102 may select the “event log” control 118 to indicate that the output of the programming instructions should print to an event log associated with the programming instructions.

FIG. 1B illustrates a generated code area 120 for displaying programming instructions 122 generated by the electronic device 104 to accomplish the determined result objectives. As shown in FIG. 1B, the programming instructions 122 may cause a processor to display an amount of free hard drive space for individual hard drives on the server xyz. Further, a first portion 124 of the programming instructions 122 illustrates that a variable included in the programming instructions has been set to the hard disk volumes of the server xyz as specified in the handwritten input 106. In addition, a second portion 126 of the programming instructions 122 illustrates the use of a function that prints output to the command line in accordance with the selection of the user 102 in the query dialog 114.

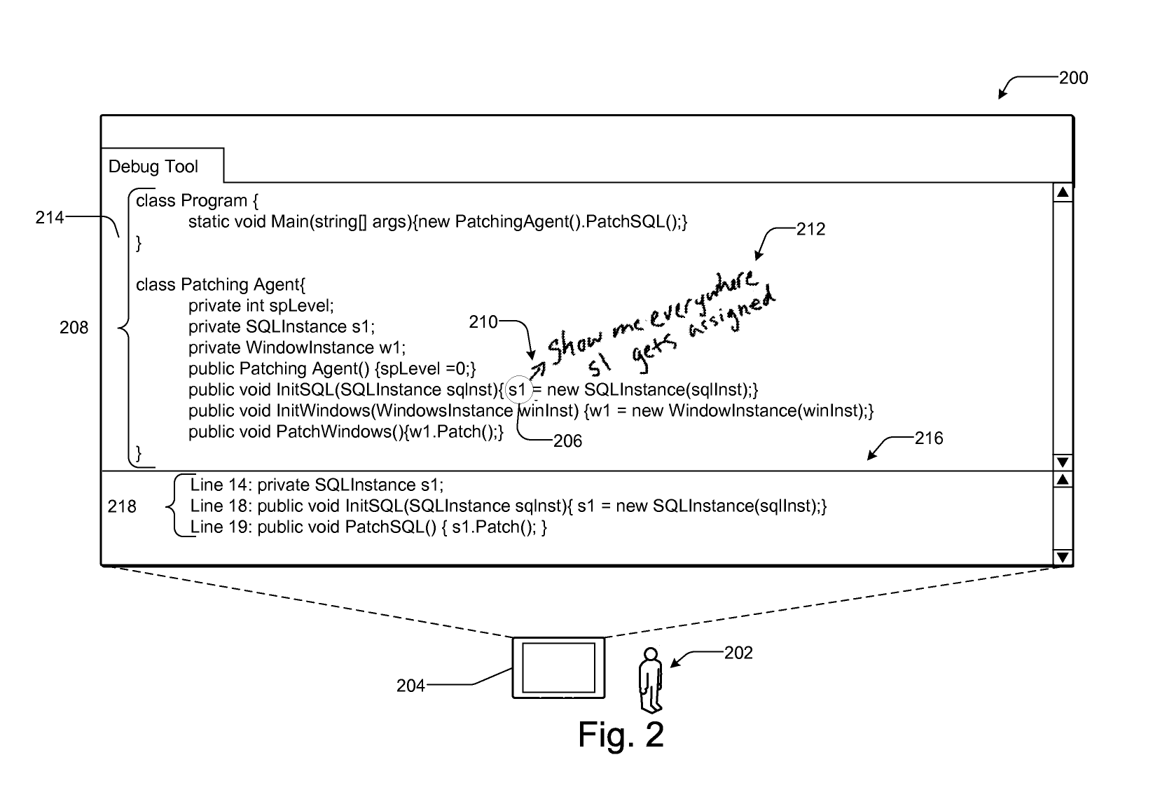

FIG. 2 illustrates an example graphical user interface 200 for computer program debugging via natural language input according to some implementations. For example, suppose the user 202 of an electronic device 204 endeavors to view all references to an object 206 within source code 208 displayed on the graphical user interface 200.

As illustrated in FIG. 2, the user 202 may input a gesture 210 and natural language input 212 via a touchscreen display 214 of the electronic device 204 or any other suitable communication technology. In some examples, the user 202 can utilize a stylus to input the gesture 210 and/or the natural language input 212. As discussed herein, the electronic device 202 can determine result objectives associated with the gesture 210 and/or natural language input 212. For example, the electronic device 204 may determine that the natural language input 212 corresponds to the object 206, given that the gesture 210 encircles the object 206. Further, the electronic device 204 may determine that locating instances of the object 206 in the source code 208 is a result objective of the gesture 210 and the natural language input 212, given the meaning of the natural language input 212 and the determination that the object 206 corresponds to the natural language input 212.

FIG. 2 further illustrates a results interface 216 that contains information pertaining to the result objective. As shown in FIG. 2, the result interface 216 can include a listing of the references 218 to the object 206 within the source code 208. Additionally, or alternatively, the information pertaining to the result objective can be displayed in other interfaces via the touchscreen display 214. For example, the references 218 to the object 206 can be highlighted within the source code 208 to visually distinguish the references 218 from the other portions of the source code 208.

As defined herein, gestures may include any combination of tapping, pressure, waving, lifting or other type of motions on or near the surface of a touchscreen by a stylus or one or more fingers. Such gestures when performed in a certain order and/or pattern will be interpreted as a particular input. As shown in FIG. 2, gestures may be used to compliment other input by a user. For instance, gestures may be used to identify information related to natural language content. As an example, a user may input natural language content requesting the natural language coding engine to locate a definition of a function. Further, the user may circle with one finger a call to the function within the source code in order to identify the particular function to the natural language coding engine.

In some other instances, a gesture may be used to communicate variable definition and assignment, a definition of a function, mathematical symbols (e.g., arithmetic operators, relational operators, logical operators, bitwise operators, assignment operators, etc), programming control structures (e.g., if expressions, while loops, for expressions, match expressions, switch expressions, etc), composition and inheritance (e.g., abstract classes, subclasses, superclasses, etc), input to an electronic device, and/or output from the electronic device.

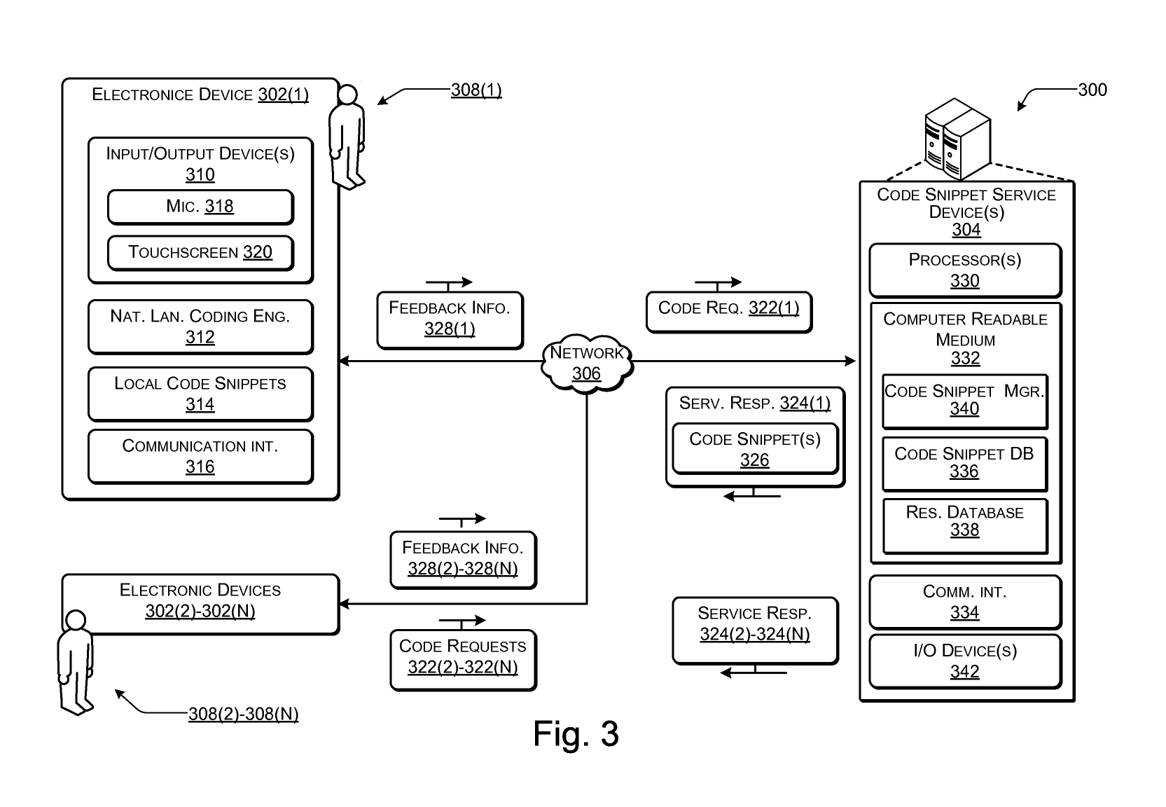

FIG. 3 illustrates an example framework 300 for implementing a code snippet service, according to some implementations. For example, the framework may enable an electronic device to receive code snippets from code snippet service providers, and modify the code snippets to accomplish result objectives.

In the illustrated example, one or more electronic devices 302 are able to communicate with one or more code snippet service devices 304 over one or more networks 306. Each electronic device 302 may be associated with a respective user 308. For example, first electronic device 302(1) may be associated with a first user 308(1). Further, other electronic devices 302(2)-302(N) may be associated with other users 308(2)-308(N). Some examples of the electronic device 302 may include tablet computing devices, smart phones and mobile devices; laptop and netbook computing devices; desktop, terminal and workstation computing devices; televisions; gaming systems; and any other device capable of collecting natural language input and communicating the natural language input to the code snippet service device 304. Further, some examples of code snippet service devices 304 may include source code repositories, code snippet repositories, and any other device capable of storing searchable code snippets and/or source code. Although, one group of code snippet service devices 304 is depicted in the framework 300 of FIG. 3, the framework 300 may also include a plurality of code snippet service devices 304 without departing from this embodiment. Additionally, individual code snippet service devices 304 may be operated by various entities.

The one or more networks 306 may be a publicly accessible network of linked networks, possibly operated by various distinct parties, such as the Internet. In other embodiments, the one or more networks 306 may include a private network, personal area network (“PAN”), local area network (“LAN”), wide area network (“WAN”), cable network, satellite network, etc. or some combination thereof, each with access to and/or from the Internet.

The electronic device 302 may include one or more input/output (“I/O”) devices 310, a natural language coding engine 312, local code snippets 314, and a communication interface 316. The input/output devices 310 of the electronic device 302 may include a microphone 318 and a touchscreen 320. Example touchscreens 320 may include resistive touch screens, surface wave touchscreens, capacitive touchscreens, infrared touchscreens, etc. The input/output devices 310 may further include a display, various user interface controls (e.g., controls, joystick, keyboard, mouse, etc.), audio speakers, connection ports and so forth. In some examples, the display may include the touchscreen 320.

To illustrate, the user 308 can utilize a stylus to input natural language content to the touchscreen 320. Further, the natural language coding engine 312 may be configured to analyze the natural language content by applying any of a number of language analysis techniques. In addition, the natural language coding engine 312 may determine one or more result objectives of the natural language content based at least in part on the analysis.

In some embodiments, the natural language coding engine 312 may determine programming instructions associated with the one or more result objectives. For instance, the natural language coding engine 312 may search the local code snippets 314 for programming instructions associated with the one or more result objectives. Performing a search of the local code snippets 314 may include identifying one or more keywords related to the result objectives, and constructing a search query comprising the identified keywords. Further, the natural language coding engine may perform a search of the local code snippets 314 based at least in part on the search query.

In some instances, the electronic device 302(1) may send a code request 322(1) for programming instructions associated with the result objectives to the code snippet service device 304. The code snippet service device 304 may also receive code requests 322(2)-322(N) from the electronic devices 302(2)-302(N), respectively. In some examples, the code request 322(1) may include result objectives derived from natural language content, one or more keywords associated with the result objectives, one or more search terms associated with the result objectives, and/or one or more search queries associated with the result objectives.

Further, the electronic device 302(1) may receive a service response 324(1) from the code snippet service device 304 in response to the code request 322(1). In some examples, the service responses 324(1) may include code snippets 326 associated with the code request 322(1). The code snippet service device 304 may also send service responses 324(2)-324(N) to the electronic devices 302(2)-302(N), respectively. In some instances, the service response 324(1) may further include information associated with the code snippets 326. For example, the service response 324(1) may include information identifying replacement parameters in the code snippets 326, application programming interface documentation associated with the code snippets 326, code examples associated with the code snippets 326, and/or ratings associated with the code snippets 326.

Upon receipt of the service response 324(1), the natural language coding engine 312 may display the code snippets 326 to the user 308 via the I/O devices 310 of the electronic device 302. Further, the electronic device 302 may receive selection of one of the code snippets 326 via the I/O devices 310 of the electronic device 302. In addition, the user 308 may manually modify portions of the code snippets 326 via the I/O devices 310.

Additionally, or alternatively, the natural language coding engine 312 may automatically modify the code snippet 326 to generate programming instructions executable to accomplish the result objectives. In some instances, the natural language coding engine 312 may modify the code snippet 326 based at last in part on one or more replacement parameters associated with the code snippet 326.

For instance, the natural language coding engine 312 may identify one or more replacement parameters. Further, the natural language coding engine 312 may substitute the replacement parameters with values associated with the result objectives. In some instances, the natural language coding engine 312 may identify replacement parameters associated with the code snippets 326 based at least in part on information within the service response 324(1). In some other instances, the natural language coding engine 312 may implement well known machine learning techniques to determine replacement parameters associated with the code snippet 326.

Further, the natural language coding engine 312 may determine values to substitute for the replacement parameters based at least in part on components of the electronic device 302, a configuration of applications installed on the electronic device 302, and/or previous activity of the user 308(1) on the electronic device 302(1). Additionally, or alternatively, the natural language coding engine 312 may implement well known machine learning techniques to determine values to substitute for the replacement parameters. In some other instances, the natural language coding engine 312 may request values to substitute for the replacement parameters from the user 308(1). For example, the electronic device 302(1) may display a query dialog, such as the query dialog 114 (shown in FIG. 1A), requesting the user 308(1) to specify values to substitute for the replacement parameters.

In some examples, the electronic device 302(1) may send feedback information 328(1) to the code snippet service device 304. Further, the code snippet service device 304 may also receive feedback information 328(2)-328(N) from the electronic devices 302(2)-302(N), respectively. Some examples of feedback information 328 may include user ratings of the code snippet 326, and/or information associated with the modification of the code snippet 326. For instance, the electronic device 302(1) may send feedback information 328(1) that includes one or more replacement parameters identified by the natural language coding engine 312 and the result objectives associated with the replacement parameters.

The communication interface(s) 316 may include one or more interfaces and hardware components for enabling communication with the code snippet service device 304 or other computing devices, over the network(s) 106 and/or another network. For example, communication interface(s) 316 may facilitate communication through one or more of the Internet, cable networks, cellular networks, wireless networks (e.g., Wi-Fi, cellular) and wired networks. Further, the electronic device 302(1) and the code snippet service device 304 may communicate via the communication interface 316 using any combination of suitable communication and networking protocols, such as Internet protocol (IP), transmission control protocol (TCP), hypertext transfer protocol (HTTP), cellular or radio communication protocols, and so forth.

As illustrated in FIG. 3, the code snippet service device 304 may include one or more processors 330, one or more computer-readable media 332, and one or more communication interfaces 334. Each processor 330 may be a single processing unit or a number of processing units, and may include single or multiple computing units or processing cores. The processor(s) 330 can be implemented as one or more microprocessors, microcomputers, microcontrollers, digital signal processors, central processing units, state machines, logic circuitries, and/or any devices that manipulate signals based on operational instructions. For instance, the processor(s) 330 may be one or more hardware processors and/or logic circuits of any suitable type specifically programmed or configured to execute the algorithms and processes described below. The processor(s) 330 can be configured to fetch and execute computer-readable instructions stored in the computer-readable media 332, which can program the processor(s) 330 to perform the functions described herein.

The computer-readable media 332 may include volatile and nonvolatile memory and/or removable and non-removable media implemented in any type of technology for storage of information, such as computer-readable instructions, data structures, program modules, or other data. Such computer-readable media 332 may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the code snippet service device 330, the computer-readable media 332 may be any type of computer-readable storage media and/or may be any tangible non-transitory media to the extent that non-transitory computer-readable media exclude media such as energy, carrier signals, electromagnetic waves, and signals per se.

The computer-readable media 332 may be used to store any number of functional components that are executable by the processors 330. In many implementations, these functional components comprise instructions or programs that are executable by the processors 330 and that, when executed, specifically configure the one or more processors 330 to perform the actions attributed herein to the code snippet service device 304. In addition, the computer-readable media 332 may store data used for performing the operations described herein. In the illustrated example, the computer-readable media 332 may store a code snippet database 336 and a resource database 338.

The code snippet database 336 may store a plurality of code snippets. In some instances, the code snippets may be accompanied by comments and/or annotations. Further, individual code snippets may be associated with programmed results. For instance, a code snippet may be associated with printing a string value to a display. In another instance, a code snippet may be associated with retrieving information from a data source. Further, the programming instructions may be written in a scripting language, a programming language, and/or an assembly language. Some example of programming instruction languages may include JavaScript, Hypertext markup Language, Java™, Python™, Ruby, C, C++, C#™, Groovy, Scala, etc.

The code snippet database 336 may store the code snippets using any suitable types of data structures, and using any suitable data storage or database techniques. Some examples of suitable data storage may include a relational database, a NoSQL database, a text file, a spreadsheet or other electronic list. Further, the code snippet database 336 may further include metadata associated with individual code snippets. In some examples, the metadata may include information associated with a code snippet. For instance, the metadata may include a description of programming results associated with a code snippet, one or more replacement parameters associated with a code snippet, one or more keywords associated with a code snippet, an author of a code snippet, a date a code snippet was added to the code snippet database 336, a last modified date, ratings and/or comments submitted by users about a code snippet, and/or one or more programming languages associated with a code snippet.

In some examples, individual code snippets may be associated with one or more resources. For instance, a code snippet may require the presence of a particular library in an execution environment executing the code snippet. Therefore, the resource database 338 may store software libraries, software development kits (“SDK”), plug-ins, and/or Application Program Interfaces (“API”) associated with the code snippets of the code snippet database 336. Further, the resource database 338 may store the resources using any suitable types of data structures, and using any suitable data storage or database techniques. In some instances, the code snippet database 336 and/or the resource database 338 may include information linking a code snippet to corresponding resources stored in the resource database 338. As used herein, a software library may include data and programming code that is used to develop software programs and applications. For example, a software library may include configuration data, documentation, help data, templates, pre-written code, subroutines, classes, values, and/or type specifications.

In the illustrated example, the functional components stored in the computer-readable media 332 may include a code snippet manager 340. Additional functional components stored in the computer-readable media 332 may include an operating system for controlling and managing various functions of the code snippet service device 304. Further, the code snippet service device 304 may include many other logical, programmatic and physical components, of which those described herein are merely examples that are related to the discussion herein.

As shown in FIG. 3, the code snippet service device 304 may receive the code request 322(1) from the electronic device 302(1). In response to receipt of the code request 322(1), the code snippet manager 340 may perform a search of the code snippet database 336 based at least in part on the contents of the code request 322(1). Further, the code snippet manager 340 may send the search results to the electronic device 302(1). For instance, the code snippet manager 340 may query the code snippet database 336 based at least in part on information associated with the result objectives of the code request 322(1) to determine that the code snippets 326 correspond to the result objectives. Further, the code snippet service device 304 may send the code snippets 326 to the electronic device 302(1) in the service response 328(1).

In some examples, the code snippet manager 340 may identify replacement parameters associated with the code snippet 326 as relevant to the code request 322(1) based at least in part on metadata associated with the code snippet. Further, the service response 324 may include information identifying the identified replacement parameters. For example, the code snippet manager 340 may mark or tag one or more portions of the code snippets 326 associated with the identified replacement parameters. For instance, a result objective may include connecting to a database using a non-default port. Further, metadata associated with the code snippet 326 may indicate that a variable in the code snippet 326 stores a default port number for connecting to the database. Therefore, the code snippet manager 340 may identify the variable as replacement parameter when sending the code snippet 326 to the electronic device 302(1).

In some other examples, the code snippet manager 340 may automatically identify replacement parameters based at least in part on analysis of the code snippet 326 and/or the results objective. For instance, the code snippet manager 340 may construct predictive models for identifying replacement parameters in a code snippet. In some examples, the code snippet manager 340 may use human generated training data to train the predictive models. For instance, the code snippet manager 340 may train the predictive models using code snippets including tags identifying replacement parameters. In addition, the code snippet manager 340 may periodically update and re-generate the predictive models based on new training data to keep the predictive models up to date.

As shown in FIG. 3, the code snippet service device 304 may receive feedback information 328 from the electronic devices. In some examples, the code snippet manager 340 may update metadata associated with code snippets database 336 based at least in part on the feedback information 328. For instance, the code snippet manager 340 may modify user submitted ratings associated with a code snippet 326 based upon ratings included in the feedback information 328(1). In some other instances, the code snippet manager 340 may modify the description and/or keywords associated with a code snippet 326. In yet another instance, the feedback information 328(1) may include one or more replacement parameters identified by electronic device 302(1). Further, the code snippet manager 340 may modify the metadata to include the replacement parameters identified by the electronic device 302(1). In addition, the code snippet manager 340 may modify the metadata to include an association between the replacement parameters identified by the electronic device 302(1) and one or more result objectives associated with the code request 322(1). In some instances, a replacement parameter identified by the electronic device 302(1) may be added to the metadata when an amount of electronic devices 302 identifying the replacement parameter is greater than a predetermined threshold.

In some examples, the code snippet manager 340 may generate a new code snippet based at least in part on feedback information 328. For instance, the code snippet manager 340 may receive feedback information 328(1) that includes one or more edits to the code snippet 326 and a description of the result objective of the edited code snippet. Further, the code snippet manager 340 may automatically create a new code snippet in the code snippet database 336 based at least in part on the edits to the code snippet 326. In some examples, the metadata associated with the new code snippet may include the description provided in the feedback information 328(1).

The communication interface(s) 342 may include one or more interfaces and hardware components for enabling communication with various other devices, such as the electronic devices 302, or other computing devices, over the network(s) 306. For example, communication interface(s) 342 may facilitate communication through one or more of the Internet, cable networks, cellular networks, wireless networks (e.g., Wi-Fi, cellular) and wired networks. As several examples, the electronic device 302(1) and the code snippet service device may communicate and interact with one another using any combination of suitable communication and networking protocols, such as Internet protocol (IP), transmission control protocol (TCP), hypertext transfer protocol (HTTP), cellular or radio communication protocols, and so forth.

The code snippet service device 304 may further be equipped with various I/O devices 342. Such I/O devices 342 may include a display, various user interface controls (e.g., controls, joystick, keyboard, mouse, touch screen, etc.), audio speakers, connection ports and so forth.

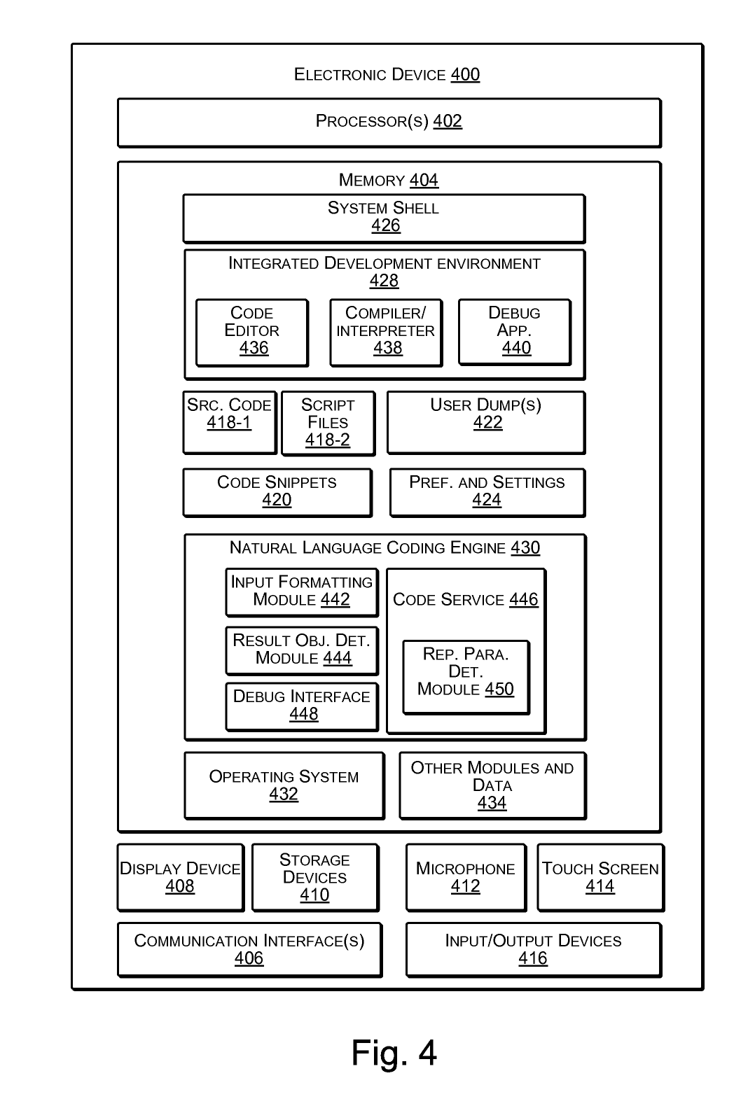

FIG. 4 illustrates an example configuration of a computing device 400 that can be used to implement the modules and functions described herein. For example, the electronic device 104, electronic device 204, and/or electronic device 302 can include an architecture that is similar to the computing device 400.

The computing device 400 can include at least one processor 402, a computer readable medium 404, communication interface(s) 406, a display device 408, one or more mass storage devices 410, a microphone 412, a touchscreen 414, and other I/O devices 416, able to communicate with each other, such as via a system bus or other suitable connection.

The processor 402 can be a single processing unit or a number of processing units, all of which can include single or multiple computing units or multiple cores. The processor 402 can be implemented as one or more microprocessors, microcomputers, microcontrollers, digital signal processors, central processing units, state machines, logic circuitries, and/or any devices that manipulate signals based on operational instructions. Among other capabilities, the processor 402 can be configured to fetch and execute computer-readable instructions stored in the memory 404, mass storage devices 410, or other computer-readable media.

Memory 404 and mass storage devices 410 are examples of computer storage media for storing instructions which are executed by the processor 402 to perform the various functions described above. For example, memory 404 can generally include both volatile memory and non-volatile memory (e.g., RAM, ROM, or the like). Further, mass storage devices 410 can generally include hard disk drives, solid-state drives, removable media, including external and removable drives, memory cards, flash memory, floppy disks, optical disks (e.g., CD, DVD), a storage array, a network attached storage, a storage area network, or the like. Both memory 404 and mass storage devices 410 can be collectively referred to as memory or computer storage media herein, and can be a non-transitory media capable of storing computer-readable, processor-executable program instructions as computer program code that can be executed by the processor 402 as a particular machine configured for carrying out the operations and functions described in the examples herein.

As used herein, “computer-readable media” includes, at least, two types of computer-readable media, namely computer storage media and communications media. Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media can embody computer readable instructions, data structures, program modules, or other data in a modulated data signal, such as a carrier wave, or other transmission mechanism. As defined herein, computer storage media does not include communication media.

Memory 404 may store data used for performing the operations described herein. In the illustrated example, the memory 404 may store source code 418-1, and script files 418-2, code snippets 420, such as local code snippets 314, user dumps 422, and preferences and settings 424.

The source code 418-1 may include collections of computer instructions for compiling/interpreting one or more applications. The script files 418-2 may include collections of computer instructions for compiling/interpreting shell scripts. In some examples, the source code 418-1 and the scripts files 418-2 may be written in one or more programming languages (e.g., Visual Basic™, C, C++, C#™, JavaScript™, Hypertext markup Language (“HTML”), Java™, Python™, Ruby, Groovy, Scala, etc.). As described herein, an “application” may be configured to execute a single task or multiple tasks. An application may be a web application, a standalone application, a widget, or any other type of application or “app.”

The user dumps 422 may include information describing the state of applications that have executed on the electronic device 400. For example, individual user dumps 422 may include an execution path of an application, a state of the working memory during execution of the application, a state of one or more variables of an application, and/or a stack trace of an application. In some instances, individual user dumps 422 may be associated with instances in which an application on the electronic device 400 has crashed or exhibited unusual behavior.

The user preferences and settings 424 may include information related to a configuration of components of the electronic device 400, a configuration of applications installed on the electronic device 400, and previous activity of the a user on the electronic device 400.

In the illustrated example, the functional components stored in the memory may include a system shell 426, an integrated development environment (“IDE”) 428, and a natural language coding engine 430. Additional functional components stored in the memory 404 may include an operating system 432 for controlling and managing various functions of the computing architecture 400. The computing architecture 400 may also include or maintain other functional components and data, such as other modules and data 434, which may include programs, drivers, etc., and the data used or generated by the functional components. Further, the computing architecture 400 may include many other logical, programmatic and physical components, of which those described above are merely examples that are related to the discussion herein.

The system shell 426 may provide a user interface for accessing the services of the operating system 432. The system shell 426 may present a prompt, interpret commands provided to the system shell 426, execute commands provided to the system shell 426, and support custom environments. Further, the user interface of the system shell 426 may include a command line interface or a graphical user interface. In some examples, the system shell 426 may also interpret or execute commands from the script files 418-2. Suitable system shells 426 include, but are not limited to, include Windows Powershell®, Bash, Ksh, Csh, Bourne Shell, and so forth.

As shown in FIG. 4, the IDE 428 may include a code editor 34236, a compiler/interpreter 438, and a debug application 440. The IDE 428 may include a software application or suite of software applications for developing applications. Suitable IDEs, according to various embodiments, include, but are not limited to, Microsoft Visual Studio®, Netbeans, Eclipse, IntelliJ Idea, etc. The code editor 34236 may provide an interface that can be used to write source code 418-1 and script files 418-2 in a specific programming language. In some instances, the code editor 34236 may validate source code syntax, highlight syntax errors, and offer corrections to syntax errors. The compiler/interpreter 438 may compile and/or interpret the source code 418-1. Further, the compiler/interpreter 438 may be used to build an executable application based at least in part on the source code 418-1 and related libraries. The debug application 440 may be used to debug applications on the electronic device 400. For example, the debug application 440 can assist a user of the electronic device 400 in locating, fixing, and bypassing bugs in the source code 418-1. Further, the debug application 440 may be used to process and display the user dumps 422. Suitable debugging applications, include, but are not limited to, Microsoft Visual Studio® Debugger, WinDbg, GNU Debugger, etc. In some instances, at least one of the code editor 34236, the compiler/interpreter 438, and/or the debugging application 440 may be separate from the IDE 428.

In the illustrated example, the natural language coding engine 430 may include an input formatting module 442, a results objective detection module 444, a code service 446, and a debugging interface 448. The input formatting module 442 may receive input from at least one of the microphone, touchscreen, or I/O devices and convert the input to a format appropriate for processing by the results objective detection module 444. For instance, the electronic device 400 may receive input by a user to the touchscreen of the electronic device 400. In some examples, the input may include handwritten text or gestures provided via a stylus. Further, the input formatting module 442 may employ well known handwriting recognition techniques and/or gesture recognition techniques to determine the content of the input and translate the input to text. In some other examples, the input may include spoken audio captured by the microphone 410. Further, the input formatting module 442 may employ well known speech recognition techniques to determine the content of the input and translate the input to text.

The results objective detection module 444 may analyze formatted input received from the input formatting module 442, and determine one or more results objectives included in the formatted input. In some embodiments, the results objective detection module 444 may be configured to determine the results objectives based at least in part on language analysis techniques, such as NLP analysis. For example, the results objective detection module 444 may identify key words included in formatted input based on simple word breaking and stemming. In another example, the results objective detection module 444 analysis may include an analysis of sets of words (“bag of words”) in formatted input. In yet another example, the results objective detection module 444 may parse formatted input into parse trees and logical forms. Techniques for identifying a result objective may further include featurizing components of at least portions of formatted input. Such techniques may employ such featurized components in a training and testing paradigm to build a statistical model to classify components of formatted input.

In some examples, determining the result objectives may be further based on the one or more user preferences and settings 424. The user preferences and settings 424 may include information related to a configuration of components of the electronic device, a configuration of applications installed on the electronic device 400, and previous activity of the user on the electronic device 400. For instance, the results objective detection module 444 may identify one or more system components referenced in formatted input based at least in part on the user preferences and settings 424. In some cases, previous activity of the user may include information related to previously identified results objectives. For instance, the results objective detection module 444 may determine one or more result objectives based at least in part on a result objective corresponding to previous input similar to the formatted input. In addition, previous activity of the user may include attributes of previous software development projects, such as the type of projects previously developed, previously used project libraries, previously used project references, etc.

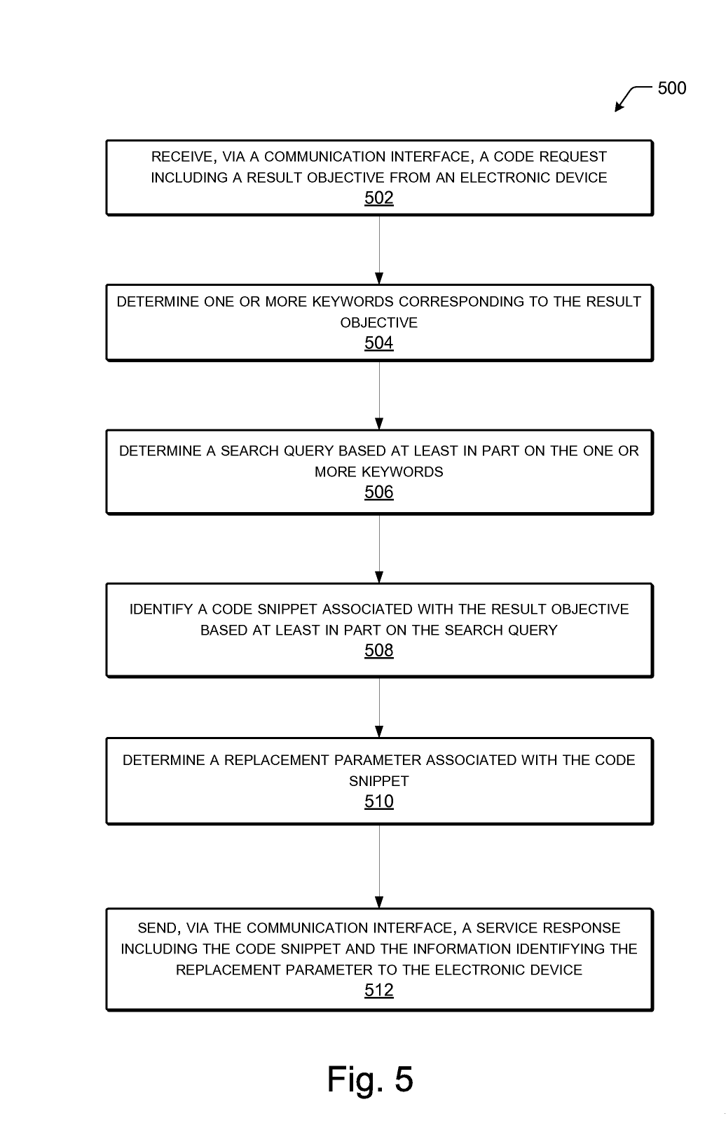

The code service 446 may receive the determined result objectives and determine programming instructions based at least in part on the determined result objectives. In some examples, the code service 446 may generate a search query based at least in part on the result objectives, and search the code snippets 420 based at least in part on the search query. Additionally, or alternatively, the code service 446 may generate a code request, and send the code request to a code snippet service, as described in FIGS. 3 and 5.

In some embodiments, the code service 446 may present one or more code snippets included in the search results to a user of the electronic device 400 via the display device 408. Further, the code service 446 may collect information from the user regarding the one or more of the code snippets included in the search results. Further, the code service may send at least a part of the collected information to a code snippet service device, such as code snippet service device 304, as feedback information, such as feedback information 328.

In some other embodiments, the code service 446 may generate executable code based at least in part on the code snippets included in the search results. For example, the code service 446 can modify a code snippet to generate executable code capable of at least partial performance of a result objective.

As illustrated in FIG. 4, the code service 446 may include a replacement parameter detection module 450. The replacement parameter detection module 450 may identify one or more replacement parameters in a code snippet 420. In some examples, the replacement parameter detection module 450 may identify replacement parameters based at least part on metadata associated with the code snippets 420. For instance, the code snippet 420 may include tags or markers that identify replacement parameters included in a code snippet 420. In some other examples, the replacement parameter detection module 450 may automatically identify replacement parameters based at least in part on analysis of the code snippet 420 and/or the results objectives.

For instance, the replacement parameter detection module 450 may construct predictive models for identifying replacement parameters in a code snippet. In some examples, the replacement parameter detection module 450 may use human generated training data to train the predictive models. For instance, the replacement parameter detection module 450 may train the predictive models using code snippets including tags identifying replacement parameters. In addition, the replacement parameter detection module 450 may periodically update and re-generate the predictive models based on new training data to keep the predictive models up to date.

In yet another example, the replacement parameter detection module 450 service may identify replacement parameters based at least in part on the compiler/interpreter 438. For instance, the replacement parameter detection module 450 may try to execute the code snippet in the compiler/interpreter 438 to determine one or more compiler errors. Further, the replacement parameter detection module 450 may analyze the identified compiler errors to determine which compiler errors correspond to a replacement parameter. For example, the replacement parameter detection module 450 may identify an undefined variable error as a replacement parameter when the undefined variable is on the right side of an assignment. In another example, the replacement parameter detection module 450 may identify an illegal identifier as a replacement parameter.

Once the replacement parameter detection module 450 has identified the replacement parameters, the code service 446 may substitute the replacement parameters in order to enable the code snippet to accomplish a result objective. For instance, the code service may request a user to provide a value for a replacement parameter. Upon receipt of the value, the code service may substitute the replacement parameter with the value.

In some instances, the code service 446 may automatically determine a substitution value for a replacement parameter. Further, the code service 446 may determine a probability that the substitution value corresponds to the result objective based at least in part on a prediction model. Further, the code service 446 may request an alternative substitution value from a user of the electronic device 400 when the probability is below a pre-determined threshold.

Upon identification of substitution values, the code service 446 may generate executable code capable of at least partial performance of a result objective by replacing the replacement parameters in the code snippet. Further, the code service 446 may auto-generate comments within the executable code. For example, the code service 446 may place comments related to the result objectives within the generated code.

In some embodiments, the code service 446 may further generate the executable code based at least in part on the preference and settings 424. For instance, the preferences and setting 424 may include a configuration of components of the electronic device, a configuration of applications installed on the electronic device 400, and previous activity of the user on the electronic device 400, predetermined formatting settings and/or a predetermined coding standard. In some examples, the predetermined formatting settings may include settings related to indentation, bracket usage, whitespace, etc. In some examples, the predetermined coding standard may include a preference for the use of particular variable types, naming conventions, design patterns, control structures, etc. For instance, the predetermined coding standard may indicate when to use a decimal, float or double type for a numerical value. In some other instances, the predetermined coding standard may indicate a preference for immutable or mutable types with regard to particular operations and/or functions.

The debug interface 448 may receive a determined result objective and cause the performance of a debugging command related to the determined result objective by the debug application 440. In some examples, the result objectives and/or debugging command may be related to thread and process management, searching source code, examining source code, editing source code, exceptions and events, loaded modules and image information, stopping and resuming execution, tracing and stepping, manipulating memory ranges, examining the stack frame, examining register state, examining the heap, examining variable state, etc.

For instance, the result objective may include determining one or more portions of source code 418-1 that reference a specified variable. Thus, the debug interface 448 may determine one or more commands associated with locating instances of the specified variable within the source code 418-1. Further, the debug interface 448 may send the one or more commands to the debug application 440. As a result, the debug application 440 may display the one or more portions of the source code 418-1 that reference the specified variable on the display device 408.

In another instance, the result objective may be related to locating the definition and assignment a specified variable. Thus, the debug interface 448 may determine one or more commands associated with locating the definition and assignment of a specified variable within the source code 418-1. Further, the debug interface 448 may send the one or more commands to the debug application 440. As a result, the debug application 440 may display the one or more portions of the source code 418-1 related to the definition and assignment of the specified variable on the display device 408.

In yet another instance, the result objective may be related to identifying a function within the user dump 422 that is related to an exception. Thus, the debug interface 448 may determine one or more commands associated with examining information associated with the function. For example, the debug interface may determine a command for inspecting the private variable of the function, a command for inspecting a stack associated with the function, a command for inspecting one or more register values associated with the function, and/or a command for determining an error code associated with the anomalous behavior of the function. Further, the debug interface 448 may send the one or more commands to the debug application 440. As a result, the debug application 440 may display information related with the function on the display device 408.

Although illustrated as a single functional block separate from the IDE 428, at least one of the natural language coding engine 430, input formatting module 442, the results objective detection module 444, the code service 446, or the debugging interface 448 may be a plug-in or component of the IDE 428 in some embodiments. Further, the natural language coding engine 430 improves the functioning of the IDE 428 by providing an efficient and user friendly means for interfacing with a user. Additionally, or alternatively, a functionality of at least one of the input formatting module 442, results objective detection module 444, code service 446, or debugging interface 448 may be included in a remote service that services the electronic device 400 in a distributed computing environment.

The computing device 400 can also include one or more communication interface(s) 406 for exchanging data with other devices, such as via a network, direct connection, or the like, as discussed above. The communication interfaces 406 can facilitate communications within a wide variety of networks and protocol types, including wired networks (e.g., LAN, cable, etc.) and wireless networks (e.g., WLAN, cellular, satellite, etc.), the Internet and the like. Communication interfaces 406 can also provide communication with external storage (not shown), such as in a storage array, network attached storage, storage area network, or the like.

A display device 408, such as a monitor can be included in some examples for displaying information and images to users. Other I/O devices 414 can be devices that receive various inputs from a user and provide various outputs to the user, and can include a camera, a keyboard, a remote controller, a mouse, a printer, audio input/output devices, and so forth.

FIG. 5 is a flow diagram 500 of an example process that may be executed by a computing device of a code snippet service provider according to some embodiments. For example, the flow diagram 500 can be used during the processing of a code request by a code snippet service device such as code snippet service device 304.

At 502, a code snippet service provider may receive, via a communication interface, a code request including a result objective from an electronic device. For example, the code snippet service provider 304 may receive the code request 322(1) including a result objective (e.g., downloading a patch from a default location and patching an anti-virus application on a plurality of file servers) from the electronic device 302(1). Additionally, or alternatively, the code request may include a search query, search terms, and/or one or more keywords associated with a result objective.

In some other examples, the code request 322(1) may include natural language input captured by the electronic device 302(1). Further, the code snippet service provider 304 may determine a result objective associated with the natural language input. For instance, the code snippet service provider 304 may convert the natural language input to corresponding text. Further, the code snippet service provider 304 may determine one or more result objectives associated with the corresponding text.

At 504, a code snippet service provider may determine one or more keywords corresponding to the result objective. For example, the code snippet manager 340 may determine that “download,” “patch,” “application,” and “server” are keywords associated with the result objective.

At 506, the code snippet service provider may determine a search query based at least in part on the one or more keywords. For example, the code snippet manager 340 may build a search query that includes “download,” “patch,” “application,” and “server” as search terms. In some examples, the code snippet manager 340 may add additional search terms to the search query. Additionally, or alternatively, the code snippet manager 340 may remove at least one of “download,” “patch,” “application,” or “server” from the search query.

At 508, the code snippet service provider may identify a code snippet associated with the result objective based at least in part on the search query. For example, the code snippet manager 340 may search the code snippet database 336 based at least in part on the search query. Further, the code snippet manager 340 may identify the code snippet 326 as relevant to the search query based on the search results. For instance, the code snippet 326 may include programming instructions that download a patch for the anti-virus software, connect to a plurality of devices, and install the patch to the devices.

In some instances, the code snippet manager 340 may request further information from the user in order to perform the search. For instance, the code snippet manager 340 may request that the user specify one or more operating systems present on the file servers. Upon receipt of a response to the request, the code snippet manager 340 may search the code snippet database 336 based at least in part on the response.

At 510, the code snippet service provider may determine a replacement parameter associated with the code snippet. For example, the code snippet manager 340 may determine one or more replacement parameters specified in metadata associated with the identified code snippet 326. For instance, the metadata associated with the code snippet may indicate that an attribute of an object representing the plurality of devices within the code snippet 326 is a replacement parameter. In some other examples, the code snippet manager 340 may determine one or more replacement parameters based at least in part on marks or tags within the code snippet 326. For instance, an attribute of an object included in the code snippet 326 that represents the plurality of devices may be highlighted as a replacement parameter within the textual content of the code snippet 326.

Further, the code snippet manager 340 may determine which replacement parameters are relevant to the code request 322(1) based on at least one of the result objective or the keywords. For instance, the code snippet may include a variable set to a default address for downloading the patch. Further, the metadata may identify the variable as a replacement parameter for the code snippet 326. However, the code snippet manager 340 may determine that the variable is not relevant replacement parameter for the code request 322(1), given that the result objective is to download the patch from the default address. Further, the code snippet manager 340 may determine that the replacement parameter corresponding to an attribute of an object included in the code snippet that represents the plurality of devices is relevant, given that the code snippet 326 does not currently specify the devices need to be patched.

At 510, the code snippet service provider may send, via the communication interface, a service response including the code snippet and the information identifying the replacement parameter to the electronic device. For example, the code snippet service provider 304 can send a service response 324(1) to the electronic device 302(1) that includes the code snippet 326 and information indicating that an attribute of an object included in the code snippet that represents the plurality of devices is a replacement parameter. In some instances, the service response 324(1) can also include replacement parameters that have been determined as not relevant to the code request 322(1). Further, the service response 324(1) may include information distinguishing the replacement parameters identified as relevant from the replacement parameters identified as not relevant.

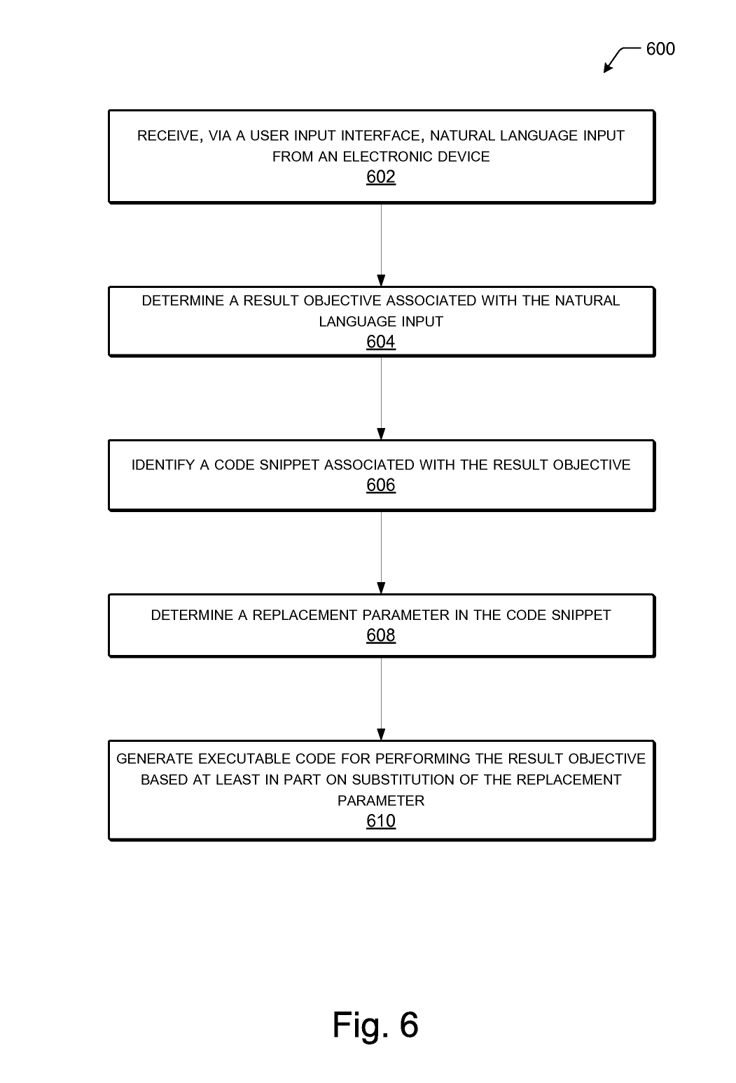

FIG. 6 is a flow diagram illustrating an example process 600 that may be executed by an electronic device for generating executable code capable of at least partial performance of a result objective based at least in part on natural language input according to some implementations.

At 602, the electronic device may receive, via a user input interface, natural language input from a user of an electronic device. For example, the electronic device 400 may receive input from a user via the I/O devices 410, 412, and 414. For instance, the electronic device 400 may receive audio input from the user via the microphone 410. In another instance, the electronic device 400 may receive handwritten input from the user via the touchscreen 412. Further, the input may include verbs, phrases and clauses intended to act as controls for the electronic device 400. In some cases, the input may further include one or more gestures.

As an example, the electronic device 400 may receive handwritten input from the user that states “request zip code from user and retrieve weather data associated with zip code from a weather service.” Further, the handwritten input may include one or more gestures. For example, a first speech bubble connected to an incoming arrow and an outgoing arrow may at least partially encircle “request zip code.” In addition, a second speech bubble connected to an outgoing arrow may at least partially encircle “weather data associated with zip code.”

At 604, the electronic device may determine a result objective associated with the natural language input. For example, the input formatting module 442 may convert input received from the user to corresponding text. In addition, the input formatting module 442 may detect one or more gestures included in the input based at least in part on well known gesture recognition techniques. Further, the result objective detection module may determine one or more result objectives associated with the corresponding text and the detected gestures.

For example, the input formatting module 442 may generate a textual representation of the handwritten input. Further, the input formatting module 442 may detect the first speech bubble gesture and associate the first speech bubble gesture to “request zip code.” Additionally, the input formatting module 442 may detect the second speech bubble gesture and associate the second speech bubble gesture with “weather data associated with zip code.”

Further, the objective detection module 444 may determine that the result objectives associated with the input are audibly requesting a user to speak a zip code, capturing audio of the user speaking the zip code, sending the zip code to a weather service, receiving weather information corresponding to the zip code, and audible playback the weather information.

At 606, the electronic device may identify a code snippet associated with the result objective. For instance, the code service 446 may search the code snippets 420 for one or more code snippets associated with the result objectives. In some examples, the code service 446 may determine one or more keywords associated with the result objectives, and generate a search query based at least in part on the keywords. Further, the code service 446 may identify a code snippet associated with at least one of the result objectives based at least in part on the search results.

In some examples, the code service may further identify one or more libraries associated with the code snippet. Further, the code service may automatically install and/or reference the one or more libraries within an execution environment, such as system shell 428 or IDE 428. Alternatively, the code service 446 may prompt the user to accept the installation and/or referencing of the one or more libraries in the execution environment

At 608, the electronic device may determine a replacement parameter in the code snippet. For example, the replacement parameter detection module 450 may determine one or more replacement parameters based at least in part on metadata associated with the identified code snippet. For instance, metadata associated with code snippet may include information identifying an expression within the code snippet as a replacement parameter. Further, the metadata may indicate that the expression is a placeholder for a web address for a weather service. In some other examples, the replacement parameter detection module 450 may determine one or more replacement parameters based at least in part on marks or tags within the code snippet. For instance, an expression within the code snippet may be highlighted or otherwise visually distinguished from the other portions of the code snippet. Further, a comment or annotation in the code snippet may indicate that the expression is a placeholder for a web address for a weather service.

Additionally, the replacement parameter detection module 450 may train a prediction model for identifying replacement parameters. Further, the replacement parameter detection module 450 may identify replacement parameters based at least in part on the trained prediction model. In some cases, the replacement parameter detection module 450 may train the predictive model using code snippets including tags identifying replacement parameters, and/or portions of code snippets mapped to keywords and/or result objectives.

At 610, the electronic device may generate executable code for performing the result objective based at least in part on substitution of the replacement parameter. For instance, the code service 446 may substitute the placeholder expression with a web address for a weather service. In some examples, the code service 446 may prompt the user for a value to substitute for the expression. In some other instances, the code service 446 may automatically determine the value. Further, the code service 446 may automatically determine the value based at least in part on at least one of the result objective or the user preference and settings 424. For instance, the code service 446 may determine that the user preferences and settings include information related to a library and/or API associated with a particular weather service. Further, the code service 446 may substitute the placeholder expression with a web address of the particular weather service. Alternatively, the code service 446 may generate a modified code snippet based at least in part on substitution of the replacement parameter. Further, the modified code snippet may require further modification before it is executable within the system shell 426 or the IDE 428.

Additionally, or alternatively, the code service may generate executable code for performing the result objective based at least in part on inserting an additional code snippet into the code snippet. In some examples, the replacement parameter may indicate an insertion point for the additional code snippet. Further, the code service may generate executable code for performing the result objective based at least in part on removing a portion of the code snippet. In some instances, the replacement parameter may indicate a portion of the code snippet that may be removed to accomplish the result objective.

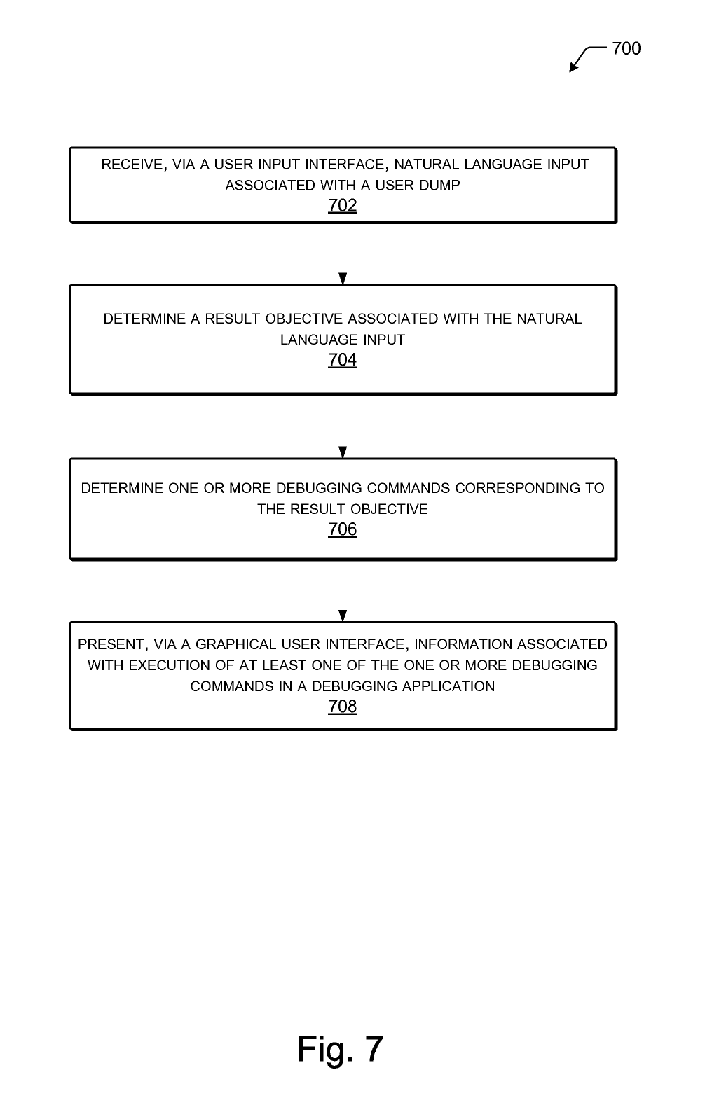

FIG. 7 is a flow diagram illustrating an example process 600 that may be executed by an electronic device for performing debugging operations via natural language input according to some implementations.

At 702, an electronic device may receive, via a user input interface, natural language input associated with a user dump. For example, the electronic device 400 may receive input from a user via the I/O devices 410, 412, and 414. For instance, the electronic device 400 may receive audio input from the user via the microphone 410. In another instance, the electronic device 400 may receive handwritten input from the user via the touchscreen 412. Further, the input may include verbs, phrases and clauses intended to act as controls for the electronic device 400. In some cases, the input may further include one or more gestures.

For instance, the electronic device 400 may receive handwritten input from the user that states “display call stack up to function and symbols related to the function.” Further, the handwritten input may include one or more gestures. For example, the handwritten input may include a circle surrounding a particular function. Further, an outgoing arrow may connect the circle to “display call stack up to function and symbols related to the function.”

At 704, the electronic device can determine a result objective associated with the natural language input. For example, the input formatting module 442 may convert input received from the user to corresponding text. In addition, the input formatting module 442 may detect one or more gestures included in the input based at least in part on well known gesture recognition techniques. Further, the result objective detection module 444 may determine one or more result objectives associated with the corresponding text and the detected gestures.

For example, the input formatting module 442 may generate a textual representation of the handwritten input. Further, the input formatting module 442 may detect the circle gesture and determine that the encircled function is the object of the natural language input (i.e., display call stack up to function and symbols related to the function).

At 706, the result objective detection module can determine one or more debugging commands corresponding to the result objective. For example, the debug interface 448 may determine that an instruction to display a call stack and an instruction to display local variables correspond to the result objective. Some other debugging commands may be related to thread and process management, searching source code, examining source code, editing source code, exceptions and events, loaded modules and image information, stopping and resuming execution, tracing and stepping, manipulating memory ranges, examining register state, examining the heap, etc.

At 708, the electronic device may present, via a graphical user interface, information associated with execution of at least one of the one or more debugging commands in a debugging application. For example, the debug interface 448 may send the one or more commands to the debug application 440. Further, the debug application 440 may cause performance of the one or more debugging commands. For instance, the electronic device 400 may display a calls interface that includes one or more function calls preceding the call of the encircled function. Further, the electronic display a locals interface that includes identifiers and values for one or more local variables in the encircled function.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

### Example Clauses

A: method, comprising: receiving, via a user input interface, natural language input from an electronic device, wherein the natural language input includes at least one of audio input or touchscreen input; determining, based at least in part on the natural language input, a result objective that identifies one or more programmable operations; identifying a code snippet associated with the result objective; determining a replacement parameter to be replaced in the code snippet to fulfill the result objective; and generating executable code for performing the result objective based at least in part on modifying the replacement parameter within the code snippet.

B: A method as paragraph A recites, further comprising generating a prediction model for identifying a portion of the code snippet that includes the replacement parameter; and wherein determining the replacement parameter in the code snippet is based at least in part on use of the prediction model.

C: A method as paragraph A or B recites, further comprising determining a system resource associated with the result objective; and wherein generating the executable code is further based at least in part on substituting the replacement parameter with a value associated with the system resource.

D: A method as any of paragraphs A-C recites, further comprising determining one or more options corresponding to the replacement parameter, wherein individual options are based, at least in part, on one or more system resources; prompting a user of the electronic device to select at least one of the one or more options; wherein generating the executable code is further based at least in part on substituting a value associated with a selected option for the replacement parameters.

E: A method as any of paragraphs A-D recites, wherein identifying a code snippet associated with the result objective further comprises: determining one or more keywords associated with the result objective; determining a search query based at least in part on the one or more keywords; and searching a database of code snippets based at least in part on the one or more keywords.

F: A method as any of paragraphs A-E recites, wherein identifying a code snippet associated with the result objective further comprises: sending a service request that includes one or more search terms associated with the result objective to a code snippet service, wherein the code snippet service includes a database storing a plurality of code snippets; and receiving a service response from the code snippet service that includes the code snippet.

G: A method as any of paragraphs A-F recites, wherein the service response further includes library information associated with the code snippet, and further comprising: determining that the library information is not referenced within an execution environment associated with the executable code; and adding a reference to the library information within the development environment.

H: A method as any of paragraphs A-G recites, wherein the natural language input is audio input captured via a microphone of the electronic device, and determining the result objective further comprises: converting the audio input to corresponding text; and performing natural language processing on the corresponding text to determine the result objective.

I: A method as any of paragraphs A-H recites, wherein the natural language input is touchscreen input captured via a touchscreen device of the electronic device, and determining the result objective further comprises: converting the touchscreen input to corresponding text; detecting one or more gestures included in the natural language input; and performing natural language processing on the corresponding text and the detected gestures to determine the result objective.

J: A method as any of paragraphs A-I recites, wherein the replacement parameter includes at least one of a variable type, variable identifier, expression, or value within the code snippet.

K: A computer readable medium having computer-executable instructions thereon, the computer-executable instructions to configure a computer to perform a method as any of paragraphs A-J recites.

L: A device comprising: a computer-readable media having computer-executable instructions thereon to configure a computer to perform a method as any one of paragraphs A-J recites, the processing unit adapted to execute the instructions to perform the method as any of paragraphs A-G recites.

M: A system comprising means for performing a method as any of paragraphs A-G recites.

N: One or more computer-readable media storing computer-executable instructions that, when executed on one or more processors, configure a computer to perform acts comprising receiving, via a user input interface, natural language input associated with a user dump; determining a result objective associated with the natural language input; determining one or more debugging commands corresponding to the result objective; and presenting, via a graphical user interface, information associated with execution of at least one of the one or more debugging commands in a debugging application.

O: One or more computer-readable as paragraph N recites, further comprising: determining source code associated with result objective; and wherein the result objective includes at least one of displaying one or more references to a variable in the source code or displaying an assignment of a variable in the source code.

P: One or more computer-readable as paragraph N or O recites, further comprising: selecting a portion of the user dump associated with the result objective; and wherein the result objective includes at least one of displaying a call stack of a function identified in the user dump or one or more local variables of a function identified in the user dump.

Q: One or more computer-readable as any of paragraphs N-P recites, wherein the natural language input includes one or more gestures, and further comprising: determining a gesture included in the natural language input, wherein the gesture identifies a portion of source code associated with the user dump; and determining that the result objective is associated with the portion of source code based at least in part on the gesture; and wherein presenting, via a graphical user interface, information associated with execution of at least one of the one or more debugging commands in a debugging application, further includes presenting debug information corresponding to the portion of source code.

R: One or more computer-readable as any of paragraphs N-Q recites, wherein: the natural language input includes audio, and determining a result objective associated with the natural language input further comprises converting the audio to corresponding text; or the natural language input includes touchscreen input, and determining a result objective associated with the natural language input further comprises converting the touchscreen input to corresponding text.

S: A service device comprising: one or more processors; a communication interface; one or more computer-readable media to store a database of a code snippets, wherein individual code snippets include a predetermined block of reusable programming instructions, and processor-executable instructions that, when executed, program the one or more processors to: receive, via the communication interface, a service request including a result objective from an electronic device; determine one or more keywords corresponding to the result objective; determine a search query based at least in part on the one or more keywords; identify a code snippet associated with the result objective based at least in part on the search query; determine a replacement parameter associated with the code snippet; and send, via the communication interface, a service response including the code snippet and information identifying the replacement parameter to the electronic device.

T: A service device as paragraph S recites, wherein the replacement parameter represents a first replacement parameter and the instructions further program the one or more processors to: receive, from the electronic device, feedback information including a second replacement parameter identified by the electronic device; and update metadata associated with the code snippet to include the second replacement parameter.

U: A service device as paragraphs S or T recites, further comprising a resource database including at least one of a library associated with the code snippet, application program interface documentation associated with the code snippet, and a code example associated with the code snippet, and wherein the service response further includes resource information from the resource database.

V: A service device as any of paragraphs S-U recites, wherein determining a replacement parameter is based at least in part on metadata associated with code snippet, and at least one of the keywords or the result objective.

W: A service device as any of paragraphs S-V recites, wherein determining a replacement parameter is based at least in part on: generating a prediction model for identifying a portion of the code snippet that includes the replacement parameter; and wherein determining the replacement parameter in the code snippet is based at least in part on use of the prediction model.

### CONCLUSION

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) 104, 204, 302, 304, and/or 400 such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof. Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A method, comprising:
receiving, via a user input interface, natural language input from an electronic device, wherein the natural language input includes at least one of audio input or touchscreen input;
determining, based at least in part on the natural language input, a result objective that identifies one or more programmable operations;
identifying a code snippet associated with the result objective;
determining a replacement parameter to be replaced in the code snippet to fulfill the result objective; and
generating executable code for performing the result objective based at least in part on modifying the replacement parameter within the code snippet.

2. The method of claim 1, further comprising;
generating a prediction model for identifying a portion of the code snippet that includes the replacement parameter; and
wherein determining the replacement parameter in the code snippet is based at least in part on use of the prediction model.

3. The method of claim 1, further comprising:
determining a system resource associated with the result objective; and wherein generating the executable code is further based at least in part on substituting the replacement parameter with a value associated with the system resource.

4. The method of claim 1, further comprising:
determining one or more options corresponding to the replacement parameter, wherein individual options are based, at least in part, on one or more system resources;
prompting a user of the electronic device to select at least one of the one or more options;
wherein generating the executable code is further based at least in part on substituting a value associated with a selected option for the replacement parameters.

5. The method of claim 1, wherein identifying a code snippet associated with the result objective further comprises:
determining one or more keywords associated with the result objective;
determining a search query based at least in part on the one or more keywords; and
searching a database of code snippets based at least in part on the one or more keywords.

6. The method of claim 1, wherein identifying a code snippet associated with the result objective further comprises:
sending a service request that includes one or more search terms associated with the result objective to a code snippet service, wherein the code snippet service includes a database storing a plurality of code snippets; and
receiving a service response from the code snippet service that includes the code snippet.

7. The method of claim 6, wherein the service response further includes library information associated with the code snippet, and further comprising:
determining that the library information is not referenced within an execution environment associated with the executable code; and
adding a reference to the library information within the development environment.

8. The method of claim 1, wherein the natural language input is audio input captured via a microphone of the electronic device, and determining the result objective further comprises:
converting the audio input to corresponding text; and
performing natural language processing on the corresponding text to determine the result objective.

9. The method of claim 1, wherein the natural language input is touchscreen input captured via a touchscreen device of the electronic device, and determining the result objective further comprises:
converting the touchscreen input to corresponding text;
detecting one or more gestures included in the natural language input; and
performing natural language processing on the corresponding text and the detected gestures to determine the result objective.

10. The method of claim 1, wherein the replacement parameter includes at least one of a variable type, variable identifier, expression, or value within the code snippet.

11. One or more computer-readable media storing computer-executable instructions that, when executed on one or more processors, configure a computer to perform acts comprising:
receiving, via a user input interface, natural language input associated with a user dump;
determining a result objective associated with the natural language input;
determining one or more debugging commands corresponding to the result objective; and
presenting, via a graphical user interface, information associated with execution of at least one of the one or more debugging commands in a debugging application.

12. The one or more non-transitory computer-readable media as recited in claim 11, further comprising:
determining source code associated with result objective; and wherein the result objective includes at least one of displaying one or more references to a variable in the source code or displaying an assignment of a variable in the source code.

13. The one or more non-transitory computer-readable media as recited in claim 11, further comprising:
selecting a portion of the user dump associated with the result objective; and wherein the result objective includes at least one of displaying a call stack of a function identified in the user dump or one or more local variables of a function identified in the user dump.

14. The one or more non-transitory computer-readable media as recited in claim 11, wherein the natural language input includes one or more gestures, and further comprising:
determining a gesture included in the natural language input, wherein the gesture identifies a portion of source code associated with the user dump; and
determining that the result objective is associated with the portion of source code based at least in part on the gesture; and
wherein presenting, via a graphical user interface, information associated with execution of at least one of the one or more debugging commands in a debugging application, further includes presenting debug information corresponding to the portion of source code.

15. The one or more non-transitory computer-readable media as recited in claim 11, wherein:
the natural language input includes audio, and determining a result objective associated with the natural language input further comprises converting the audio to corresponding text; or
the natural language input includes touchscreen input, and determining a result objective associated with the natural language input further comprises converting the touchscreen input to corresponding text.

16. A service device comprising:
one or more processors;
a communication interface;
one or more computer-readable media to store a database of a code snippets, wherein individual code snippets include a predetermined block of reusable programming instructions, and processor-executable instructions that, when executed, program the one or more processors to:
receive, via the communication interface, a service request including a result objective from an electronic device;
determine one or more keywords corresponding to the result objective;
determine a search query based at least in part on the one or more keywords;
identify a code snippet associated with the result objective based at least in part on the search query;
determine a replacement parameter associated with the code snippet; and
send, via the communication interface, a service response including the code snippet and information identifying the replacement parameter to the electronic device.

17. The service device as recited in claim 16, wherein the replacement parameter represents a first replacement parameter and the instructions further program the one or more processors to:
receive, from the electronic device, feedback information including a second replacement parameter identified by the electronic device; and
update metadata associated with the code snippet to include the second replacement parameter.

18. The service device as recited in claim 16, further comprising a resource database including at least one of a library associated with the code snippet, application program interface documentation associated with the code snippet, and a code example associated with the code snippet, and wherein the service response further includes resource information from the resource database.

19. The service device as recited in claim 16, wherein determining a replacement parameter is based at least in part on metadata associated with code snippet, and at least one of the keywords or the result objective.

20. The service device as recited in claim 16, wherein determining a replacement parameter is based at least in part on:
generating a prediction model for identifying a portion of the code snippet that includes the replacement parameter; and
wherein determining the replacement parameter in the code snippet is based at least in part on use of the prediction model.
